(19) United States
(12) Patent Application Publication
(10) Pub. No.: US 2010/0225234 A1
(43) Pub. Date: Sep. 9, 2010

(54) Hollow-cathode plasma generator

(75) Inventors: Ching-Pei Tseng, Keelung City (TW); Cheng-Chang Hsieh, Chiayi City (TW); Chi-Fong Ai, Longtan Shiang (TW); Chia-Cheng Lee, Sanchong City (TW); Tien-Hsiang Hsueh, Xindian City (TW); Chun-Han Wang, Taipei City (TW)

Correspondence Address: Jackson Intellectual Property Group PLLC, 106 Starvale Lane, Shipman, VA, 22971, US

(73) Assignee: ATOMIC ENERGY COUNCIL - INSTITUTE OF NUCLEAR ENERGY RESEARCH, Taoyuan (TW)

(21) Appl. No.: 11/896,620

(22) Filed: Sep. 4, 2007

(51) Int. Cl. H05H 1/24

(52) U.S. Cl. 315/111.21

(57) ABSTRACT

A hollow-cathode plasma generator includes a plurality of hollow cathodes joined together and connected to a power supply for generating plasma in vacuum. Each of the hollow cathodes includes at least one fillister defined therein, a fin formed on a side of the fillister, an air-circulating tunnel in communication with the fillister and a coolant-circulating tunnel defined therein. The fillister is used to contain working gas. The fin receives negative voltage from the power supply for ionizing the working gas to generate the plasma and spread the plasma in a single direction. The working gas travels into the fillister from the air-circulating tunnel. The coolant-circulating tunnel is used to circulate coolant for cooling the hollow cathode.

### BACKGROUND OF INVENTION

1. Field of Invention

The present invention relates to a hollow-cathode plasma generator and, more particularly, to a hollow-cathode plasma generator including a changeable number of hollow cathodes, a changeable width and a changeable degree of vacuum and using various power supplies to generate plasma from evenly distributed gas and spread the plasma in a single direction.

2. Related Prior Art

A conventional hollow-cathode plasma generator includes a flat electrode disposed in a chamber. Air is pumped out of the chamber before working gas such as argon and oxygen is filled in the chamber. Direct current (“DC”) or pulsed DC is used to create negative voltage in the flat electrode, thus creating an electric field. In operation, the pressure is 1 to 10⁻² torr in the chamber. The electric field causes electrons to accelerate and hit and ionize the neutral working gas so that plasma is generated.

The plasma is conductive. The intensity of the electric field declines in an exponential manner as it gets further from the flat electrode. Hence, the plasma spreads in all directions over the flat electrode. The electric field causes the electrons to accelerate and spread in all directions in the chamber and hit various neutral particles. The electrons with higher levels of energy hit the neutral particles with lower levels of energy to cause ionization that generates more ions and electrons, thus forming the plasma. The plasma spreads in a wide region so that the average density thereof is low and that the performance thereof is low.

Disclosed in U.S. Pat. No. 4,767,641 is a hollow-cathode plasma generator including a power source for energizing a hollow cathode disposed in a chamber to generate plasma. The hollow cathode may be made in various forms such as square, hexagonal and rectangular.

Disclosed in U.S. Pat. No. 5,113,790 is a hollow-cathode plasma generator including magnets disposed in fillisters defined in cathodes to increate the density of plasma. As the magnets are disposed in the fillisters, the magnetic force lines however penetrate partitions between the fillisters so that the material of the partitions is sputtered and pollutes the chamber. Moreover, when used to generate intense plasma or used at high power, the hollow-cathode plasma generator generates much heat that must be radiated by an extra cooling device. The hollow-cathode plasma generator cannot be used at high power for a long time without such an extra cooling device, and is not suitable for practical use.

The present invention is therefore intended to obviate or at least alleviate the problems encountered in prior art.

### SUMMARY OF INVENTION

It is an objective of the present invention to provide a hollow-cathode plasma generator including a changeable number of hollow cathodes, a changeable width and a changeable degree of vacuum and using various power sources to generate plasma from evenly distributed gas and spread the plasma in a single direction.

It is another objective that the present invention provides a hollow-cathode plasma generator including a configuration providing excellent heat-radiating effects and a cooling device for further cooling so that its activation width can easily be increased, it can be used at high power to increase the density of plasma in certain zones and that it can generate at a high rate for a long time.

There is still another objective of the present invention to provide a hollow-cathode plasma generator with a changeable length by including a changeable number of hollow cathodes, each includes at least one fillister that is rectangular, square, circular, hexagonal, polygonal or in any other proper shape.

To achieve the foregoing objectives, the present invention provides a hollow-cathode plasma generator including a plurality of hollow cathodes joined together and connected to a power supply for generating plasma in vacuum. Each of the hollow cathodes includes at least one fillister defined therein, a fin formed on a side of the fillister, an air-circulating tunnel in communication with the fillister and a coolant-circulating tunnel defined therein. The fillister is used to contain working gas. The receives negative voltage from the power supply for ionizing the working gas to generate the plasma and spread the plasma in a single direction. The working gas travels into the fillister from the air-circulating tunnel. The coolant-circulating tunnel is used to circulate coolant for cooling the hollow cathode.

Other objectives, advantages and features of the present invention will become apparent from the following description referring to the attached drawings.

### BRIEF DESCRIPTION OF DRAWINGS

The present invention will be described via detailed illustration of embodiment referring to the drawings.

FIG. 1 is a perspective view of a hollow cathode for use in a hollow-cathode plasma generator according to a first embodiment of the present invention.

FIG. 2 is a perspective view of a hollow-cathode plasma generator consisting of hollow cathodes as shown in FIG. 1.

FIG. 3 is a perspective view of a hollow cathode for use in a hollow-cathode plasma generator according to a second embodiment of the present invention.

FIG. 4 is a perspective view of a hollow cathode for use in a hollow-cathode plasma generator according to a third embodiment of the present invention.

FIG. 5 is a perspective view of a hollow cathode for use in a hollow-cathode plasma generator according to a fourth embodiment of the present invention.

### DETAILED DESCRIPTION OF EMBODIMENT

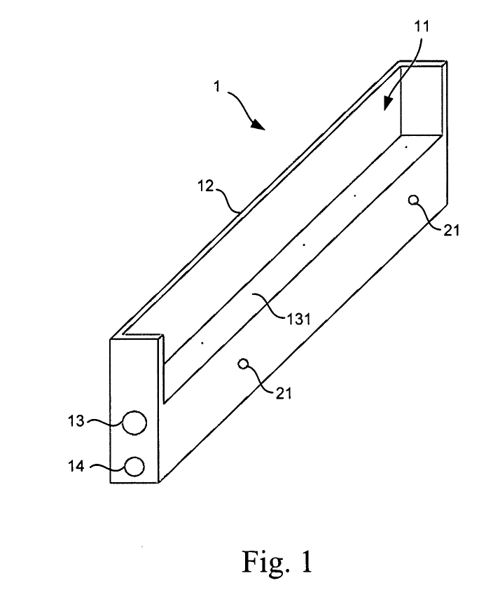

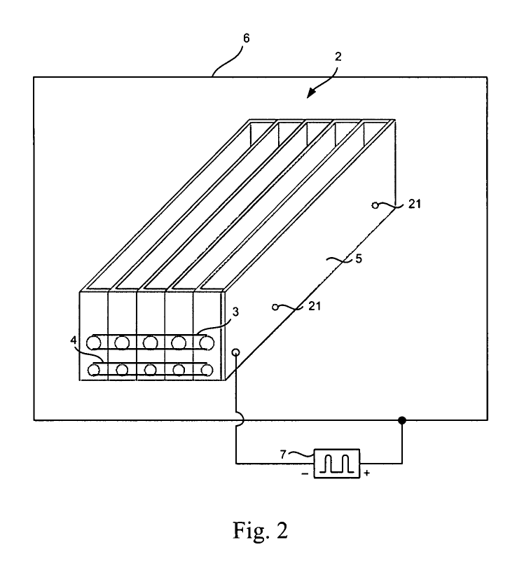

Referring to FIGS. 1 and 2, a hollow-cathode plasma generator 2 includes a plurality of hollow cathodes 1 disposed in a chamber 6 according to a first embodiment of the present invention. Each of the hollow cathodes 1 includes a fillister 11 defined therein and a fin 12 formed on a side of the fillister 12. The fillister 11 is open on an opposite side. Moreover, each of the hollow cathodes 1 includes a gas-transferring tunnel 13 defined therein, a coolant-circulating tunnel 14 defined therein and a plurality of pores 131 defined therein for communicating the gas-transferring tunnel 13 with the fillister 11. The diameter of the pores 131 and the distance between two adjacent ones of the pores 131 are determined based on the degree of vacuum in the chamber 6, the size of the hollow-cathode plasma generator 2 and the height of the fin 12. The diameter of the pores 131 and the distance between two adjacent ones of the pores 131 are determined based on each other. If the degree of vacuum is 2×10⁻² torr and the height of the fin 12 is 30 mm for example, the diameter of the pores 131 is 0.3 mm and the distance between two adjacent ones of the pores 131 is 30 mm.

The hollow-cathode plasma generator 2 includes a side board 5 in addition to the hollow cathodes 1. The hollow cathodes 1 and the side board 5 are joined together. Each of the hollow cathodes 1 includes two apertures 21 defined therein for example. The side board 5 also includes two apertures defined therein. The hollow cathodes 1 are located side by side. The side board 5 is located against one of the hollow cathodes 1 opposite to the fin 11 of the hollow cathode 1. Two fasteners such as threaded bolts are inserted through the apertures 21 so that the hollow cathodes 1 and the side board 5 are connected to one another. The number of the hollow cathodes 1 and the length of the hollow-cathode plasma generator 2 can be changed to meet different needs. Thus, the hollow-cathode plasma generator 2 is made.

In use, the hollow-cathode plasma generator 2 is disposed in the chamber 6. The air-circulating tunnel 13 of each of the hollow cathodes 1 includes an end connected to a common air-circulating conduit 3 and an opposite end closed by a common cover. Working gas is introduced into the air-circulating tunnels 13 from the air-circulating conduit 3. Then, the working gas is introduced into the fillisters 11 from the air-circulating tunnels 13 through the pores 131. In vacuum, a power supply 7 provides the hollow-cathode plasma generator 2 with negative voltage, electrons are limited in the fillister 11 and can easily hit and ionize the working gas, thus generating plasma. By increasing the number of the pores 131 and the diameter of the gas-transferring tunnels 13, the working gas exerts even pressure on the walls of the gas-transferring tunnels 13. The working gas goes from the pores 131, which are evenly deployed, and evenly spread in the fillister 11. The current of the working gas carries the plasma onto a piece of work located outside of the fillister 11 so that the piece of work can be processed by the plasma.

Moreover, to generate high-density plasma, the power of the hollow-cathode plasma generator 2 is increased as well as reducing the pressure in the chamber 6. Coolant such as cooling water is used to cool the hollow-cathode plasma generator 2 used at high power. To this end, the coolant-circulating tunnel 14 of each of the hollow cathodes 1 includes an end (“inlet”) connected to a common coolant-circulating conduit 4 and an opposite end (“outlet”) left open. The coolant flows into the coolant-circulating tunnels 14 from the coolant-circulating conduit 4 through the inlets. The coolant leaves the coolant-circulating tunnels 14 from the outlets. With the coolant circulating outside of the fillisters 11 and cooling the hollow-cathode plasma generator 2, the power of the hollow-cathode plasma generator 2 can be increased to 10 KW. If the size of the hollow-cathode plasma generator 2 is 1500 mm×147 MM, the power supply 7 supplies a pulsed DC at 350 KHz, and the hollow-cathode plasma generator 2 operates at 10 KW for instance, the density of the plasma 30 mm from a target surface will be 5.05×10¹⁰ cm⁻³. The power supply however may be a DC, pulsed DC or radio-frequency (“RF”) power supply.

Therefore, the hollow-cathode plasma generator 2 can be operated at high power to increase the density of the plasma used to activate certain regions. On the other hand, it can finish high polymer plasma activation in a short period of time. It can be used in a roll-to-roll vacuum system. It is suitable for any plasma stage of an inline process so that the efficiency of the plasma stage and that of the inline process are increased.

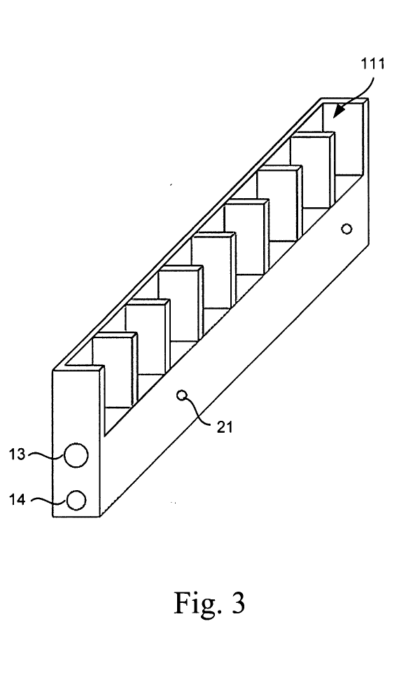

Referring to FIG. 3, there is a hollow cathode 1 for use in a hollow-cathode plasma generator 2 according to a second embodiment of the present invention. The hollow cathode 1 for use in the second embodiment is like the hollow cathode 1 for use in the first embodiment except including many fillisters 111 instead of the single fillister 11. Each of the fillisters 111 is in communication with a related one of the pores 131. The fillisters 111 are rectangular.

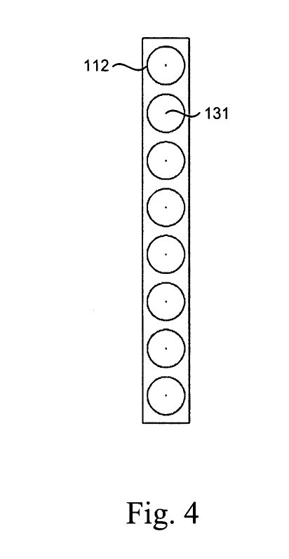

Referring to FIG. 4, there is a hollow cathode 1 for use in a hollow-cathode plasma generator 2 according to a third embodiment of the present invention. The hollow cathode 1 for use in the third embodiment is identical to the hollow cathode 1 for use in the second embodiment except including fillisters 112 instead of the fillisters 111. Each of the fillisters 112 is oval.

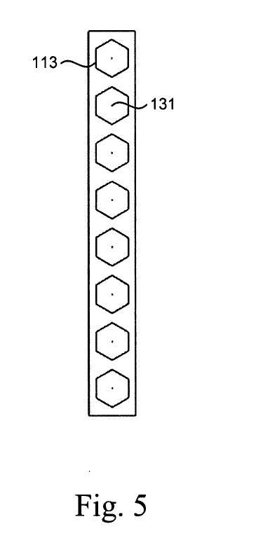

Referring to FIG. 5, there is a hollow cathode 1 for use in a hollow-cathode plasma generator 2 according to a fourth embodiment of the present invention. The hollow cathode 1 of the fourth embodiment is identical to the hollow cathode 1 of the third embodiment except including many fillisters 113 instead of the fillisters 112. The fillisters 113 are hexagonal.

As discussed referring to FIGS. 3 through 5, each of the hollow cathode 1 in the hollow-cathode plasma generator 2 may include one fillister or more in any shape.

Conclusively, the hollow-cathode plasma generator according to the present invention overcomes the drawbacks addressed in the Related Prior Art. Firstly, its width, the number of the hollow cathodes and the degree of the vacuum in the chamber can be changed. Secondly, various power supplies can be used to generate the plasma. Thirdly, the plasma is spread in a single direction. Fourthly, the heat radiation is excellent. Fifthly, it can be made with an increased activation width and used at high power so that the density of the plasma is increased in certain regions. Sixthly, it can be used to process pieces of work at a high rate for a long time.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A hollow-cathode plasma generator comprising a plurality of hollow cathodes joined together and connected to a power supply for generating plasma in vacuum, each of the hollow cathodes comprising:
at least one fillister defined therein for containing working gas;
a fin formed on a side of the fillister for receiving negative voltage from the power supply for ionizing the working gas to generate the plasma and spread the plasma in a single direction;
an air-circulating tunnel in communication with the fillister so that the working gas travels into the fillister from the air-circulating tunnel; and
a coolant-circulating tunnel defined therein for circulating coolant for cooling the hollow cathode.

2. The hollow-cathode plasma generator according to claim 1, wherein the power supply is selected from a group consisting of a DC power supply, a pulsed DC power supply and an RF power supply.

3. The hollow-cathode plasma generator according to claim 1, wherein the hollow-cathode plasma generator can be operated at 10 KW.

4. The hollow-cathode plasma generator according to claim 1, wherein the shape of the fillister is selected from a group consisting of a rectangle, a square, an oval, a hexagon and a polygon.

5. The hollow-cathode plasma generator according to claim 1, wherein the width of the fillister and the height of the fin are determined based on the degree of the vacuum.

6. The hollow-cathode plasma generator according to claim 1, wherein each of the cathodes comprises a plurality of pores for communicating the fillister to the air-circulating tunnel.

7. The hollow-cathode plasma generator according to claim 6, wherein each of the hollow cathodes comprises a plurality of fillisters each in communication with a related one of the pores.

8. The hollow-cathode plasma generator according to claim 6, wherein the diameter and number of the pores are determined based on the degree of the vacuum and the height of the fins.

9. The hollow-cathode plasma generator according to claim 8, wherein the diameter and number of the pores are determined based on each other.

10. The hollow-cathode plasma generator according to claim 1 comprising at least one fastener, wherein each of the hollow cathodes comprises at least one aperture for receiving the fastener so that the hollow cathodes are connected to each other.

11. The hollow-cathode plasma generator according to claim 10 comprising a side board connected to one of the hollow cathodes by the fastener.
